(19) United States
(12) Patent Application Publication
(10) Pub. No.: US 2013/0198419 A1
(43) Pub. Date: Aug. 1, 2013

(54) LOCK-FREE FIFO

(71) Applicants: Stephen Jones, San Francisco, CA (US); Xiaohuang Huang, Hangzhou (CN)

(72) Inventors: Stephen Jones, San Francisco, CA (US); Xiaohuang Huang, Hangzhou (CN)

(21) Appl. No.: 13/361,781

(22) Filed: Jan. 30, 2012

(51) Int. Cl. G06F 3/00

(52) U.S. Cl. 710/54

(57) ABSTRACT

One embodiment of the present invention sets forth a technique that allows multiple producers and/or consumers to access a first-in first-out sub-system (FIFO) using a “lock-free” mechanism. When two or more producers attempt to push data onto the FIFO simultaneously, only one of the producers succeeds. Similarly, when two or more consumers attempt to pop data from the FIFO simultaneously, only one of the consumers succeeds. However, each producer and consumer is provided with an indication of whether their respective access was successful. Unsuccessful accesses may be retried in the following clock cycle, so that simultaneous accesses are serialized.

### BACKGROUND OF THE INVENTION

1. Field of the Invention

The present invention generally relates to a first-in first-out sub-system (FIFO) and more specifically to a lock-free FIFO.

2. Description of the Related Art

A conventional FIFO allows for a head FIFO entry to be pushed and a tail FIFO entry to be popped during a single clock cycle. Such a FIFO is adequate for systems in which a single producer fills the FIFO and a single consumer empties the FIFO. When multiple consumers and/or producers simultaneously attempt to access the FIFO only a single consumer and a single producer will succeed. However, a conventional FIFO does not indicate which of the multiple consumers and/or producers accessed the FIFO successfully. Thus, all consumers and/or producers will incorrectly assume that their respective access was successful when, in fact, only a single consumer and producer can access the FIFO successfully during a clock cycle.

Typically, access to a conventional FIFO is controlled using a locking mechanism to ensure that only a single producer and a single consumer can access the FIFO in a single clock cycle. When the FIFO is locked by one consumer, no other consumer may access the FIFO. Similarly, when the FIFO is locked by one producer, no other producer may access the FIFO. Implementation of the locking mechanism is complex.

Accordingly, what is needed in the art is an improved system and method for allowing multiple producers and/or consumers to access a FIFO.

### SUMMARY OF THE INVENTION

One embodiment of the present invention sets forth a technique for allowing multiple producers and/or consumers to access a FIFO. A lock-free mechanism is used to access the FIFO so that multiple consumers and/or producers may simultaneously access the FIFO without first obtaining a lock.

Various embodiments of a method of the invention for accessing a lock-free FIFO sub-system, include receiving a pop request to pop a FIFO head node from the lock-free FIFO, reading a FIFO head pointer value from a lock-free FIFO data structure, and reading a next value that is included in the FIFO head node and identifies a second FIFO node in the lock-free FIFO. An atomic compare-and-swap operation is performed to compare the FIFO head pointer value with a current FIFO head pointer value stored in the lock-free FIFO data structure. If the FIFO head pointer value equals the current FIFO head pointer value for the atomic compare-and-swap operation then exchanging the next value with the current FIFO head pointer value in the lock-free FIFO data structure to update the FIFO head pointer value. Otherwise, if the FIFO head pointer value does not equal the current FIFO head pointer value for the atomic compare-and-swap operation then repeating the reading of the FIFO head pointer value, the reading of the next value, and the performing of the atomic compare-and-swap operation.

A “lock-free” mechanism allows multiple producers and/or consumers to access a FIFO. When two or more producers attempt to push data onto the FIFO simultaneously, only one of the producers succeeds. Similarly, when two or more consumers attempt to pop data from the FIFO simultaneously, only one of the consumers succeeds. However, each producer and consumer is provided with an indication of whether their respective access was successful. Unsuccessful accesses may be retried in the following clock cycle, so that simultaneous accesses are serialized.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3A is a block diagram of a GPC within one of the PPUs of FIG. 2, according to one embodiment of the present invention;

FIG. 3B is a block diagram of a partition unit within one of the PPUs of FIG. 2, according to one embodiment of the present invention;

FIG. 3C is a block diagram of a portion of the SM of FIG. 3B, according to one embodiment of the present invention;

FIG. 4 is a conceptual diagram of a lock-free FIFO, according to one embodiment of the present invention;

FIG. 5A is a flow diagram of method steps for popping a FIFO head node from a lock-free FIFO, according to one embodiment of the present invention;

FIG. 5B is another flow diagram of method steps for popping a FIFO head node from a lock-free FIFO, according to one embodiment of the present invention; and

FIG. 6 is a flow diagram of method steps for pushing a FIFO node onto a lock-free FIFO, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

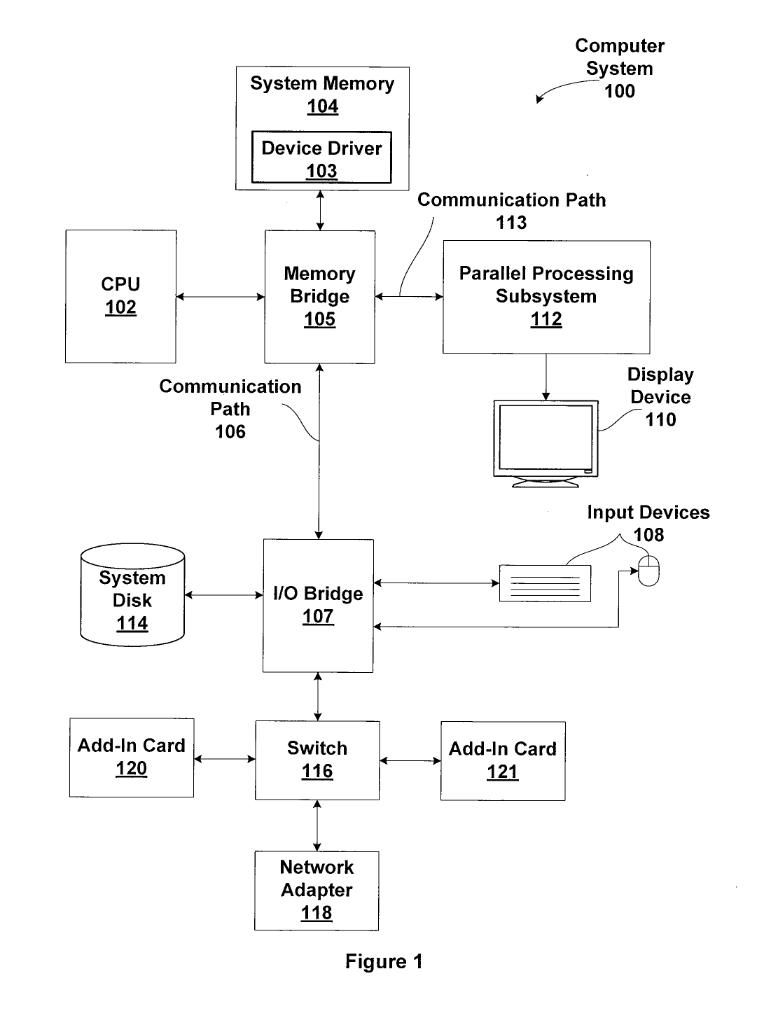

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 (e.g., a conventional cathode ray tube or liquid crystal display based monitor). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) or other port connections, compact disc (CD) drives, digital video disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

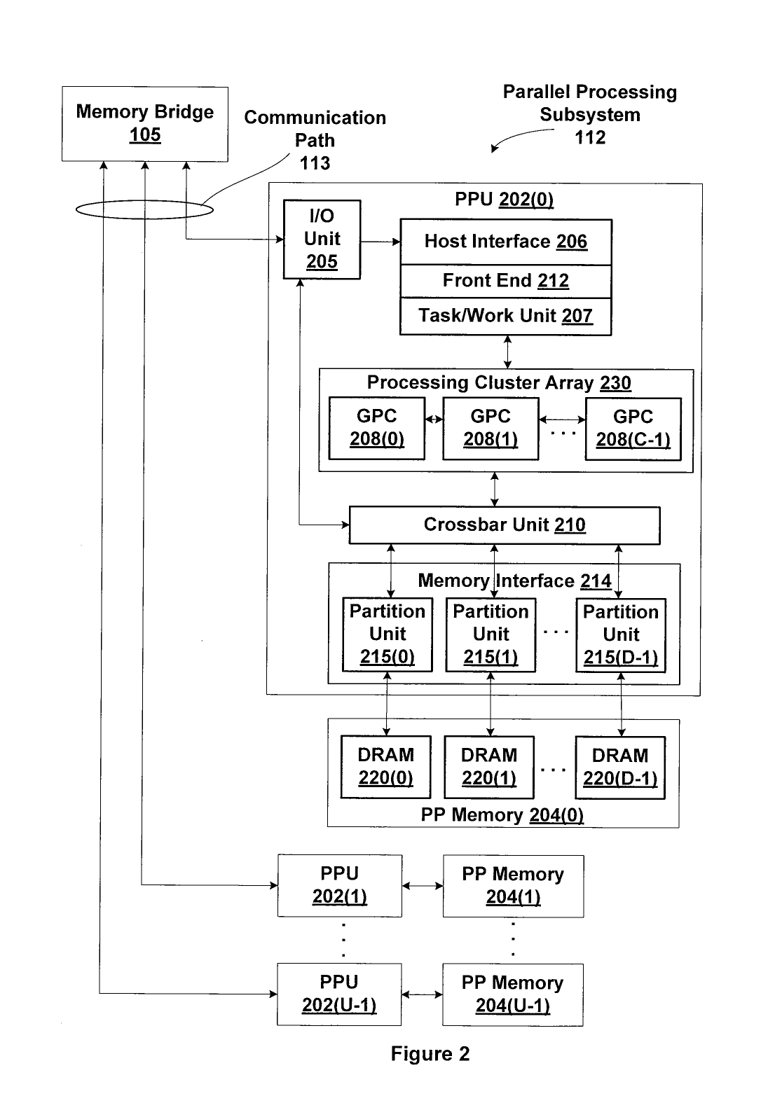

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1 as well as FIG. 2, in some embodiments, some or all of PPUs 202 in parallel processing subsystem 112 are graphics processors with rendering pipelines that can be configured to perform various operations related to generating pixel data from graphics data supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to display device 110 or each PPU 202 in parallel processing subsystem 112 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Processing tasks can also be received from the processing cluster array 230. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D 1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Multiple Concurrent Task Scheduling

Multiple processing tasks may be executed concurrently on the GPCs 208 and a processing task may generate one or more “child” processing tasks during execution. The task/work unit 207 receives the tasks and dynamically schedules the processing tasks and child processing tasks for execution by the GPCs 208.

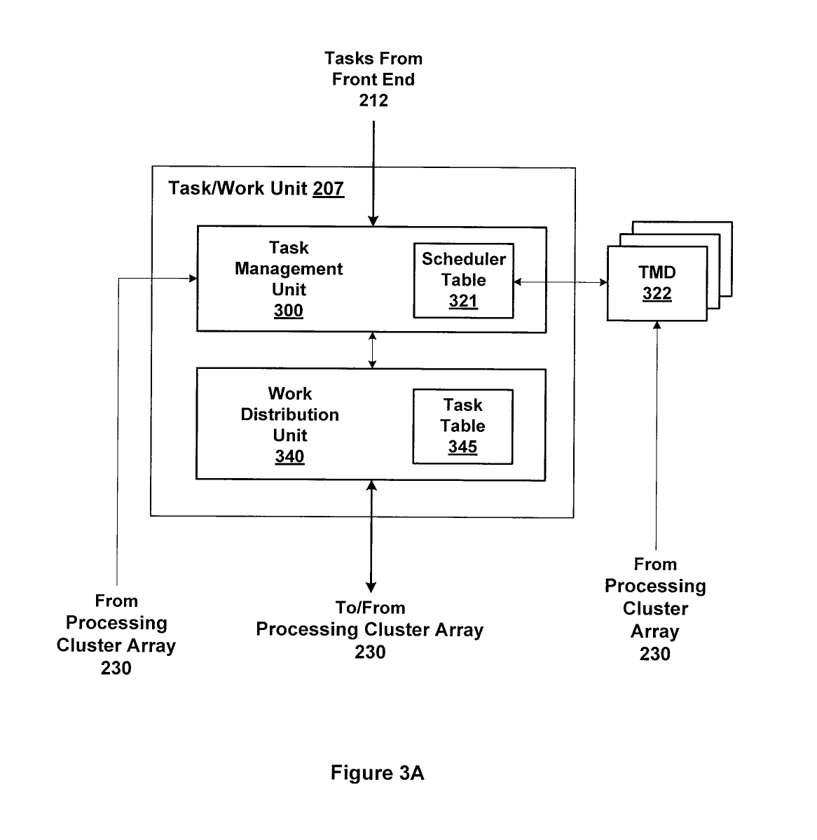

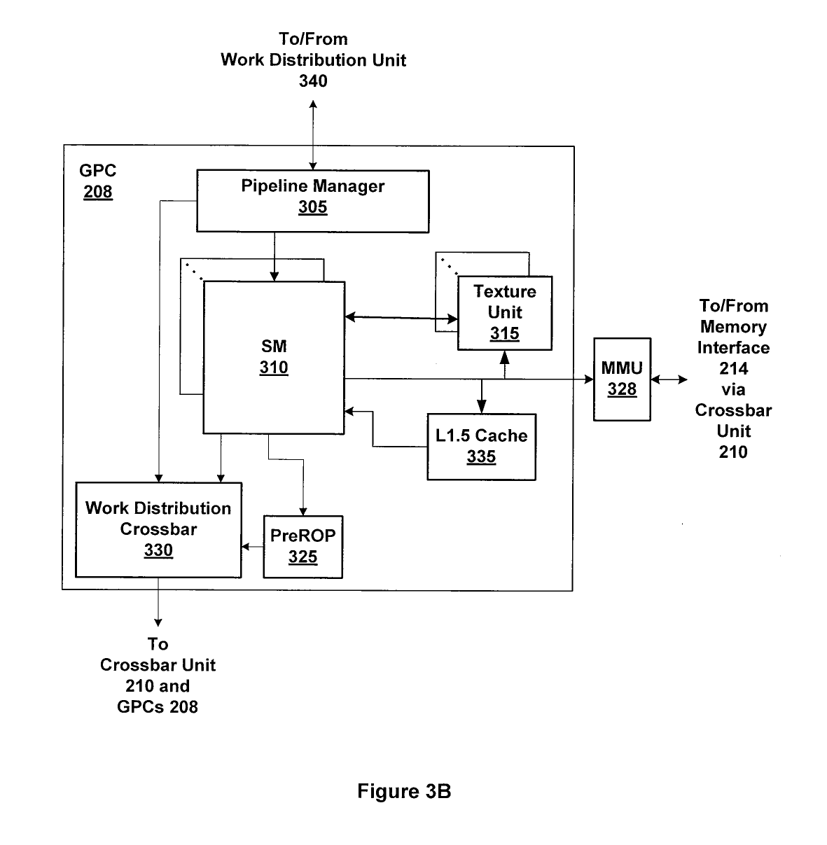

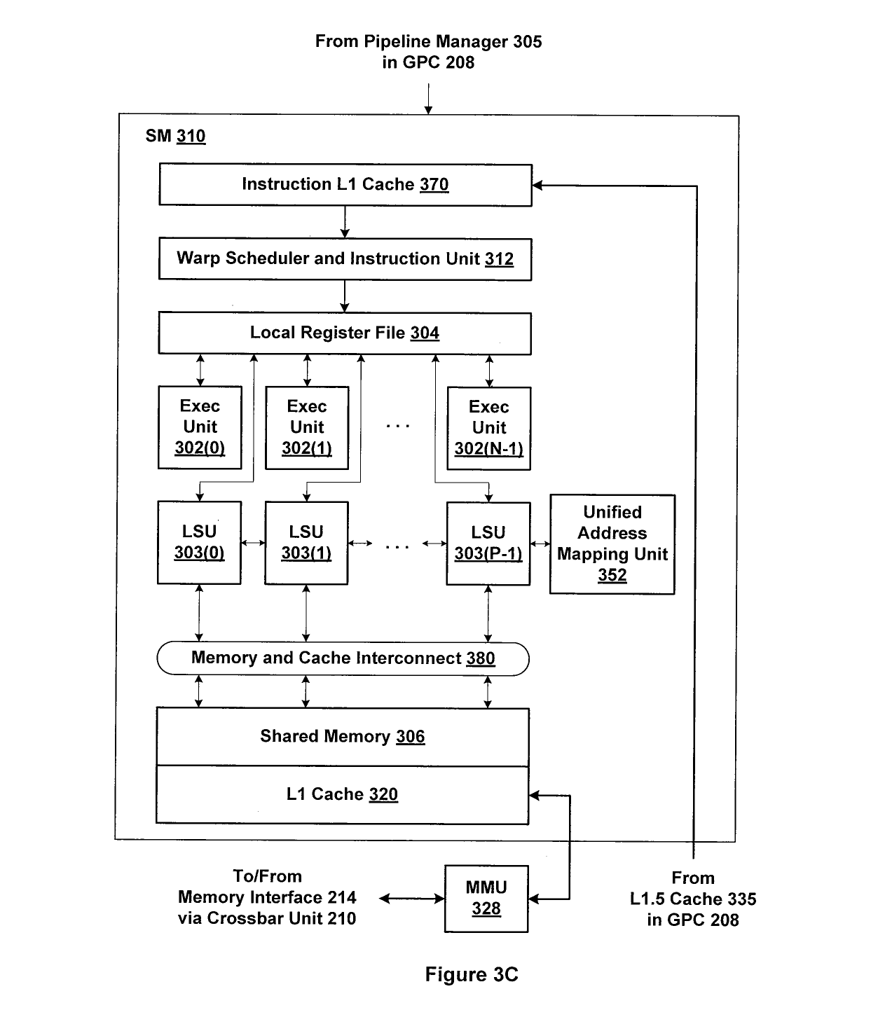

FIG. 3A is a block diagram of the task/work unit 207 of FIG. 2, according to one embodiment of the present invention. The task/work unit 207 includes a task management unit 300 and the work distribution unit 340. The task management unit 300 organizes tasks to be scheduled based on execution priority levels. For each priority level, the task management unit 300 stores a list of pointers to the TMDs 322 corresponding to the tasks in the scheduler table 321, where the list may be implemented as a linked list. The TMDs 322 may be stored in the PP memory 204 or system memory 104. The rate at which the task management unit 300 accepts tasks and stores the tasks in the scheduler table 321 is decoupled from the rate at which the task management unit 300 schedules tasks for execution. Therefore, the task management unit 300 may collect several tasks before scheduling the tasks. The collected tasks may then be scheduled , based on priority information or using other techniques, such as round-robin scheduling.

The work distribution unit 340 includes a task table 345 with slots that may each be occupied by the TMD 322 for a task that is being executed. The task management unit 300 may schedule tasks for execution when there is a free slot in the task table 345. When there is not a free slot, a higher priority task that does not occupy a slot may evict a lower priority task that does occupy a slot. When a task is evicted, the task is stopped, and if execution of the task is not complete, then a pointer to the task is added to a list of task pointers to be scheduled so that execution of the task will resume at a later time. When a child processing task is generated, during execution of a task, a pointer to the child task is added to the list of task pointers to be scheduled. A child task may be generated by a TMD 322 executing in the processing cluster array 230.

Unlike a task that is received by the task/work unit 207 from the front end 212, child tasks are received from the processing cluster array 230. Child tasks are not inserted into pushbuffers or transmitted to the front end. The CPU 102 is not notified when a child task is generated or data for the child task is stored in memory. Another difference between the tasks that are provided through pushbuffers and child tasks is that the tasks provided through the pushbuffers are defined by the application program whereas the child tasks are dynamically generated during execution of the tasks.

### Task Processing Overview

FIG. 3B is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons of ordinary skill in the art will understand that a SIMD processing regime represents a functional subset of a SIMT processing regime.

Operation of GPC 208 is advantageously controlled via a pipeline manager 305 that distributes processing tasks to streaming multiprocessors (SMs) 310. Pipeline manager 305 may also be configured to control a work distribution crossbar 330 by specifying destinations for processed data output by SMs 310.

In one embodiment, each GPC 208 includes a number M of SMs 310, where M≧1, each SM 310 configured to process one or more thread groups. Also, each SM 310 advantageously includes an identical set of functional execution units (e.g., execution units and load-store units—shown as Exec units 302 and LSUs 303 in FIG. 3C) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SM 310 is referred to herein as a “warp” or “thread group.” As used herein, a “thread group” refers to a group of threads concurrently executing the same program on different input data, with one thread of the group being assigned to a different processing engine within an SM 310. A thread group may include fewer threads than the number of processing engines within the SM 310, in which case some processing engines will be idle during cycles when that thread group is being processed. A thread group may also include more threads than the number of processing engines within the SM 310, in which case processing will take place over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SM 310, and m is the number of thread groups simultaneously active within the SM 310. The size of a CTA is generally determined by the programmer and the amount of hardware resources, such as memory or registers, available to the CTA.

Each SM 310 contains a level one (L1) cache (shown in FIG. 3C) or uses space in a corresponding L1 cache outside of the SM 310 that is used to perform load and store operations. Each SM 310 also has access to level two (L2) caches that are shared among all GPCs 208 and may be used to transfer data between threads. Finally, SMs 310 also have access to off-chip “global” memory, which can include, e.g., parallel processing memory 204 and/or system memory 104. It is to be understood that any memory external to PPU 202 may be used as global memory. Additionally, a level one-point-five (L1.5) cache 335 may be included within the GPC 208, configured to receive and hold data fetched from memory via memory interface 214 requested by SM 310, including instructions, uniform data, and constant data, and provide the requested data to SM 310. Embodiments having multiple SMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SM 310 or the L1 cache or GPC 208. The physical address is processed to distribute surface data access locality to allow efficient request interleaving among partition units 215. The cache line index may be used to determine whether or not a request for a cache line is a hit or miss.

In graphics and computing applications, a GPC 208 may be configured such that each SM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SM 310 and is fetched from an L2 cache that is shared between all GPCs 208, parallel processing memory 204, or system memory 104, as needed. Each SM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SMs 310 or texture units 315, preROPs 325 may be included within a GPC 208. Further, as shown in FIG. 2, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches to execute tasks for one or more application programs.

Persons of ordinary skill in the art will understand that the architecture described in FIGS. 1, 2, 3A, and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 202 or other processor(s) of a computing system to execute general-purpose computations using thread arrays. Each thread in the thread array is assigned a unique thread identifier (“thread ID”) that is accessible to the thread during the thread's execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

FIG. 3C is a block diagram of the SM 310 of FIG. 3B, according to one embodiment of the present invention. The SM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SM 310 functional units according to the instructions and constants. The SM 310 functional units include N exec (execution or processing) units 302 and P load-store units (LSU) 303.

SM 310 provides on-chip (internal) data storage with different levels of accessibility. Special registers (not shown) are readable but not writeable by LSU 303 and are used to store parameters defining each thread's “position.” In one embodiment, special registers include one register per thread (or per exec unit 302 within SM 310) that stores a thread ID; each thread ID register is accessible only by a respective one of the exec unit 302. Special registers may also include additional registers, readable by all threads that execute the same processing task represented by a TMD 322 (or by all LSUs 303) that store a CTA identifier, the CTA dimensions, the dimensions of a grid to which the CTA belongs (or queue position if the TMD 322 encodes a queue task instead of a grid task), and an identifier of the TMD 322 to which the CTA is assigned.

If the TMD 322 is a grid TMD, execution of the TMD 322 causes a fixed number of CTAs to be launched and executed to process the fixed amount of data stored in the queue 525. The number of CTAs is specified as the product of the grid width, height, and depth. The fixed amount of data may be stored in the TMD 322 or the TMD 322 may store a pointer to the data that will be processed by the CTAs. The TMD 322 also stores a starting address of the program that is executed by the CTAs.

If the TMD 322 is a queue TMD, then a queue feature of the TMD 322 is used, meaning that the amount of data to be processed is not necessarily fixed. Queue entries store data for processing by the CTAs assigned to the TMD 322. The queue entries may also represent a child task that is generated by another TMD 322 during execution of a thread, thereby providing nested parallelism. Typically, execution of the thread, or CTA that includes the thread, is suspended until execution of the child task completes. The queue may be stored in the TMD 322 or separately from the TMD 322, in which case the TMD 322 stores a queue pointer to the queue. Advantageously, data generated by the child task may be written to the queue while the TMD 322 representing the child task is executing. The queue may be implemented as a circular queue so that the total amount of data is not limited to the size of the queue.

CTAs that belong to a grid have implicit grid width, height, and depth parameters indicating the position of the respective CTA within the grid. Special registers are written during initialization in response to commands received via front end 212 from device driver 103 and do not change during execution of a processing task. The front end 212 schedules each processing task for execution. Each CTA is associated with a specific TMD 322 for concurrent execution of one or more tasks. Additionally, a single GPC 208 may execute multiple tasks concurrently.

A parameter memory (not shown) stores runtime parameters (constants) that can be read but not written by any thread within the same CTA (or any LSU 303). In one embodiment, device driver 103 provides parameters to the parameter memory before directing SM 310 to begin execution of a task that uses these parameters. Any thread within any CTA (or any exec unit 302 within SM 310) can access global memory through a memory interface 214. Portions of global memory may be stored in the L1 cache 320.

Local register file 304 is used by each thread as scratch space; each register is allocated for the exclusive use of one thread, and data in any of local register file 304 is accessible only to the thread to which the register is allocated. Local register file 304 can be implemented as a register file that is physically or logically divided into P lanes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMD execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers. Additionally, a uniform L1 cache 375 stores uniform or constant values for each lane of the N exec units 302 and P load-store units LSU 303.

Shared memory 306 is accessible to threads within a single CTA; in other words, any location in shared memory 306 is accessible to any thread within the same CTA (or to any processing engine within SM 310). Shared memory 306 can be implemented as a shared register file or shared on-chip cache memory with an interconnect that allows any processing engine to read from or write to any location in the shared memory. In other embodiments, shared state space might map onto a per-CTA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA ID and task ID, as well as CTA and grid dimensions or queue position, implementing portions of the special registers. Each LSU 303 in SM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

The L1 cache 320 in each SM 310 can be used to cache private per-thread local data and also per-application global data. In some embodiments, the per-CTA shared data may be cached in the L1 cache 320. The LSUs 303 are coupled to the shared memory 306 and the L1 cache 320 via a memory and cache interconnect 380.

### A Lock-Free FIFO

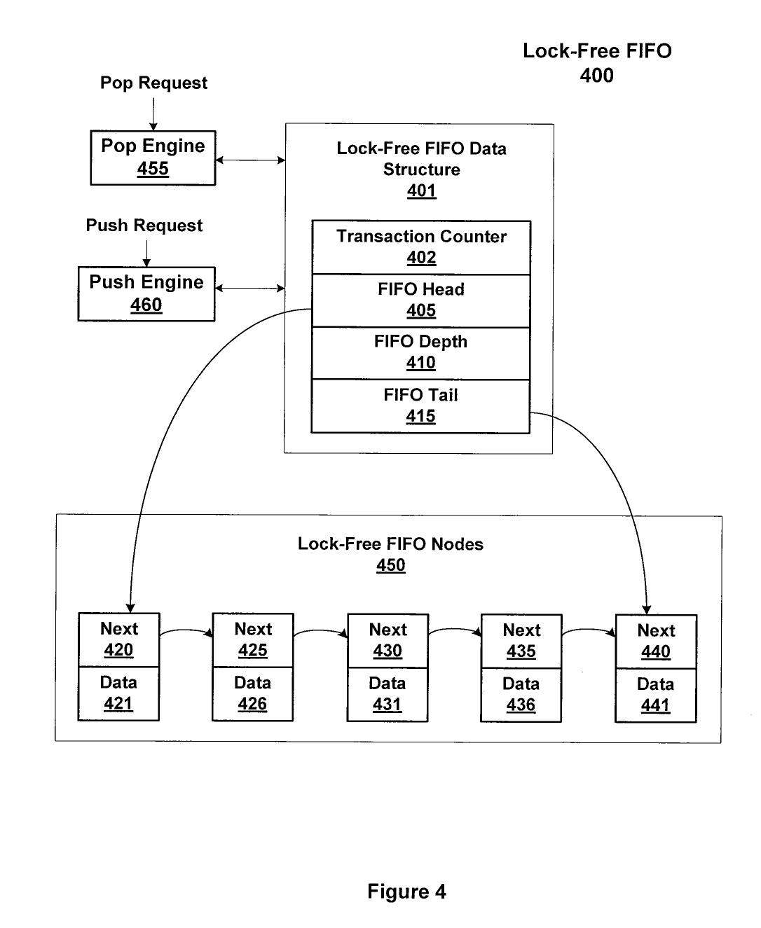

FIG. 4 is a diagram of a lock-free FIFO 400, according to one embodiment of the present invention. The lock-free FIFO 400 includes a lock-free FIFO data structure 401, a pop engine 455, a push engine 460, and lock-free FIFO nodes 450. The lock-free FIFO nodes 450 is a linked-list of entries within the lock-free FIFO 400, where each entry is a FIFO node that includes a “next” pointer to the next FIFO node in the linked-list and “data”. As shown in FIG. 4 the FIFO head node includes next 420 and data 421. Next 420 points to a second FIFO node that includes next 425 and data 426. Next 425 points to a third FIFO node that includes next 430 and data 431. Next 430 points to a fourth FIFO node that includes next 435 and data 436. Next 435 points to the tail FIFO node that includes next 440 and data 441. Although only five nodes are shown in FIG. 4, fewer or additional nodes may be used. In one embodiment, the number of nodes is limited only by the amount of memory available for storing the lock-free FIFO 450.

The lock-free FIFO data structure 401 stores state information stored for the lock-free FIFO 400 including a transaction counter 402, a pointer to the FIFO head 405, a pointer to the FIFO tail 415, and a FIFO depth 410. In one embodiment the state information includes one or more other values, such as parameters that are used to determine whether additional FIFO entries should be added to the lock-free FIFO 400.

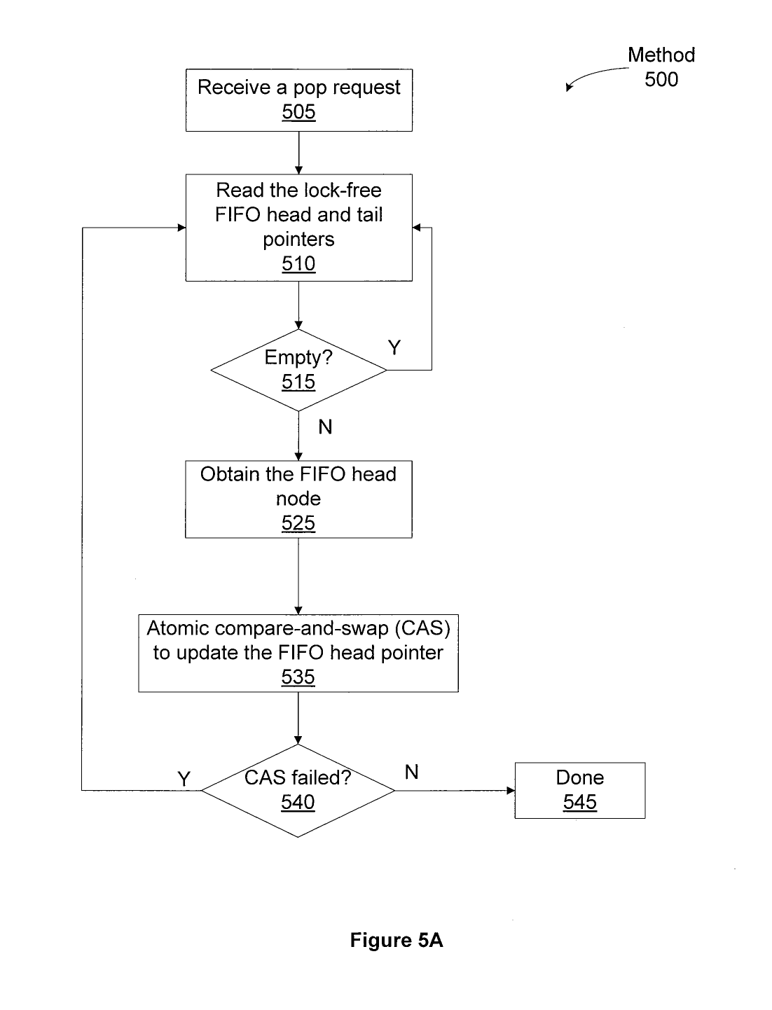

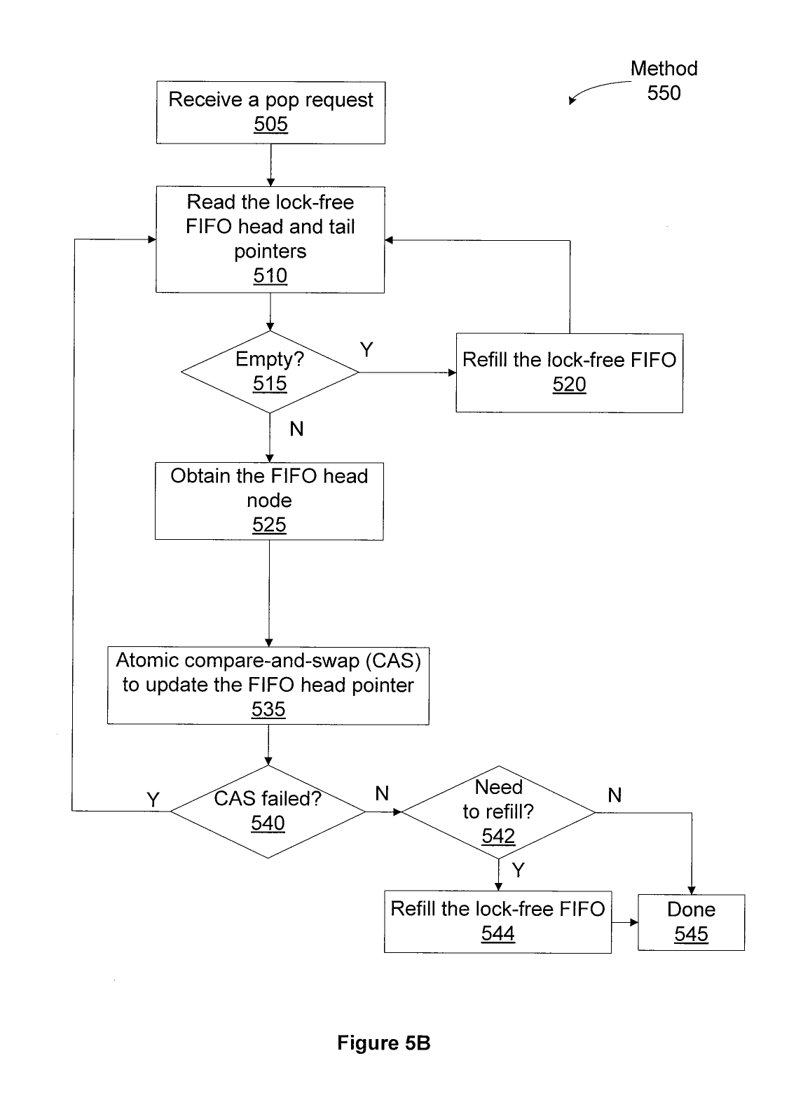

The pop engine 455 is configured to receive one or more pop requests simultaneously and to pop the head FIFO node from the lock-free FIFO 400 and return a pointer to the popped FIFO node to satisfy one of the pop requests each clock cycle. The pop engine 455 updates the FIFO head 405. For example, when the FIFO head node including next 420 and data 421 is popped, the pop engine 455 updates the FIFO head 405 to point to the new head FIFO node that includes next 425 and data 426. The operations performed by the pop engine 455 are described in conjunction with FIGS. 5A and 5B.

Whenever the head FIFO node is popped from the lock-free FIFO 400 the transaction counter 402 is incremented. The transaction counter is used by atomic compare-and-swap operations that update the FIFO head 405, as described further herein.

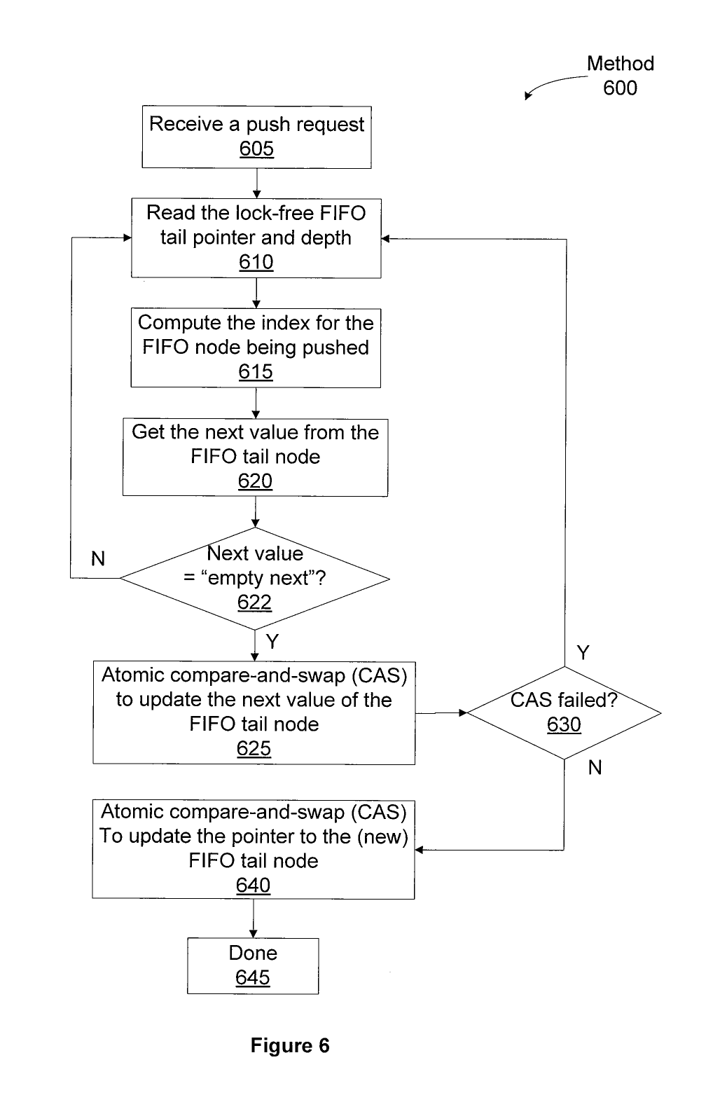

The push engine 460 is configured to receive one or more push requests simultaneously and to push a new FIFO node that is received with the push request onto the end of the lock-free FIFO 400. The new FIFO node is added to the linked-list in the lock-free FIFO nodes 450. For example, when the new FIFO node that includes next 440 and data 441 was pushed, the next 435 of the current tail FIFO node is updated to point to the new FIFO node. The push engine 455 then updates the FIFO tail 415 to point to the new tail FIFO node that includes next 440 and data 441. The operations performed by the push engine 460 are described in conjunction with FIG. 6. The pop engine 455 and the push engine 460 may be implemented in software that is executed by a processing engine or as dedicated circuitry such as a finite-state machine.

Each FIFO node is a portion of memory that stores the “next” and “data” values. In one embodiment, when the FIFO nodes are first allocated to the lock-free FIFO 400, the FIFO nodes are in sequential portions of linear memory. While the FIFO nodes are popped in sequential order, the FIFO nodes may be pushed back onto the lock-fee-FIFO 400 in a different order. Therefore, a “next” value must be maintained for each FIFO node in the lock-free FIFO nodes 450.

In one embodiment the “next” values, the FIFO head 405, and the FIFO tail 415 specify a location in memory for a respective FIFO node. In embodiments in which the FIFO nodes are allocated sequentially from linear memory, the “next” values, the FIFO head 405, and the FIFO tail 415 may specify an index that is combined with at least a base location in memory to compute the location in memory for each respective FIFO node.

In one embodiment, new FIFO nodes may be allocated automatically for the lock-free FIFO 400 and the new FIFO nodes may easily be added to the linked list of lock-free FIFO nodes 450 by inserting the new FIFO nodes at the end of the linked list. Parameters stored in the lock-free FIFO data structure 401 may be used to determine whether additional FIFO nodes should be added automatically to the lock-free FIFO 400. For example, a programmable threshold value may be defined and new FIFO nodes may be added to the linked-list in the lock-free FIFO nodes 450 when the FIFO depth 410 falls below the threshold value. A programmable empty timeout parameter may also be defined and included in the lock-free FIFO data structure 401. Additional FIFO nodes may be added to the linked-list in the lock-fee FIFO nodes 450 when the FIFO depth 410 equals zero for a number of clock cycles that is greater than the empty timeout value. Other parameters that may be included in the lock-free FIFO data structure 401 are constants that cannot be modified by a FIFO operation (push or pop), such as a maximum FIFO depth value and a maximum node index value. For embodiments that do not support the addition of new FIFO nodes to the linked list of lock-free FIFO nodes 450, the FIFO depth 410 parameter may be omitted from the lock-free FIFO data structure 401.

In order to allow multiple threads to simultaneously attempt to access the lock-free FIFO 400 without first locking the FIFO for each access, atomic compare-and-swap (CAS) operations are performed by the pop engine 455 and the push engine 460. Using atomic operations ensures that read-modify-write operations performed by a thread to update the FIFO head 405, FIFO tail 415, and to update a “next” value of a FIFO node do not conflict with those performed by any other thread during the same clock cycle. The reliance on atomic operations imposes an upper-bound for the value of the FIFO depth 410. Specifically, N, the number of FIFO nodes in a lock-free FIFO, can be any number so long as it is no larger than the maximum number of bits which may manipulated atomically by the hardware.

FIG. 5A is a flow diagram of method steps for popping a FIFO node from the lock-free FIFO 400, according to one embodiment of the present invention. Although the method steps are described in conjunction with the systems of FIGS. 1, 2, 3A, 3B, 3C, and 4, persons skilled in the art will understand that any system configured to perform the method steps, in any order, is within the scope of the invention.

The method 500 shown in FIG. 5A is performed by the pop engine 455 for each pop request to pop the FIFO head node from the lock-free FIFO 400. The method 500 is performed for each pop request when pop requests are simultaneously received from different threads. Therefore, the method 500 may be performed simultaneously for multiple pop requests. However, a given FIFO head node is provided to only one thread of the different threads to satisfy the pop request presented by the one thread.

At step 505 a pop request is received from a thread. At step 510 the pop engine 455 reads the FIFO head 405 and the FIFO tail 415. The pop engine 455 may also read the transaction count 401. At step 515 the pop engine 455 determines if the FIFO head 405 equals the FIFO tail 415, indicating that the lock-free FIFO 400 is empty, i.e., the same FIFO node is both the head FIFO node and the tail FIFO node. Alternatively, the FIFO depth 410 may be used to determine if the lock-free FIFO 400 is empty.

If, at step 515 the pop engine 455 determines that the lock-free FIFO 400 is empty, then steps 510 and 515 are repeated. In one embodiment, when a pop operation is attempted and the lock-free FIFO 400 is empty a failure is indicated after a predetermined number of failed pop operations and/or after a timeout has expired. Otherwise, at step 525 the pop engine 455 obtains the FIFO head node. More specifically, the pop engine 455 may read the data for the FIFO head node so that the data can be provided to the thread that successfully pops the FIFO head node. Alternatively, the pop engine 455 may provide the index of the FIFO head node to the thread that successfully pops the FIFO head node.

At step 535 the pop engine 455 performs an atomic CAS operation that compares the FIFO head value read at step 510 with the current FIFO head 505 and replaces the current FIFO head 505 with the “next” value of the current FIFO head node (the same FIFO head node that is popped). For example, if the FIFO head node 405 points to the FIFO node including next 420 and data 421, then popping the head FIFO node will update the FIFO head node 405 to point to the FIFO node including next 425 and data 426. Importantly, because multiple threads may be attempting to pop the FIFO head node at the same time, updating the FIFO head 405 must be performed atomically. The atomic CAS operation to update the FIFO head 405 is performed for each thread presenting a pop request to the pop engine 455. The CAS operation succeeds for only one thread and fails for any other threads attempting to simultaneously pop the FIFO head node. The FIFO depth 410 and the transaction counter 402 are also updated at the same time and using the same atomic CAS operation that updates the FIFO head 405. If the atomic CAS operation is limited to a maximum number of bits, e.g., 32, 64, or 128, then the combined number of bits that represent the FIFO head 405, FIFO depth 410, transaction counter 402, and the FIFO tail 415 should not exceed the maximum number of bits.

If, at step 540 the pop engine 455 determines that the CAS operation failed for the pop request, then the pop engine 455 returns to step 510 to retry the pop request. If, at step 540 the pop engine 455 determines that the CAS operation did not fail for the pop request, then at step 545 the pop request is satisfied and the processing of the pop request is done.

FIG. 5B is another flow diagram of method steps for popping the head FIFO node from the lock-free FIFO 400, according to one embodiment of the present invention. Method 550 includes steps 505, 510, 515, 525, 535, 540, and 545 from method 500. Steps 505, 510, and 515 are performed as previously described in conjunction with FIG. 5A. If, at step 515 the pop engine 455 determines that the lock-free FIFO 400 is empty, then at step 520 the pop engine 455 refills the lock-free FIFO 400 by adding new FIFO nodes to the tail of the lock-free FIFO nodes 450 before returning to step 510. If, at step 515 the pop engine 455 determines that the lock-free FIFO 400 is not empty, then the pop engine 455 proceeds to step 525.

Steps 525, 535, and 540 are completed as previously described in conjunction with FIG. 5A. If, at step 540 the pop engine 455 determines that the CAS operation failed for the pop request, then at step 542 the pop engine 455 determines if the FIFO needs to be refilled. The parameters stored in the lock-free FIFO data structure 401 may be used to determine whether new FIFO nodes should be added to the linked list in the lock-free FIFO nodes 450. If, at step 542 the pop engine 455 determines that the lock-free FIFO 400 does not need to be refilled, then at step 545 the processing of the pop request is done. Otherwise, at step 544 the pop engine 455 adds new FIFO nodes to the linked list before proceeding to step 545. When a thread is in the process of adding new FIFO nodes to the linked list, a flag is set to prevent other threads from also trying to add new FIFO nodes at the same time. Only a single thread needs to add the new FIFO nodes to prevent the lock-free FIFO 400 from being empty.

Although method 550 illustrates two different steps (520 and 544) that add new FIFO nodes to the linked list, other embodiments may include only one of steps 520 and 544. For example, an embodiment that is configured to refill the lock-free FIFO 400 when the lock-free FIFO 400 is empty may include step 520. Another embodiment that is configured to refill the lock-free FIFO 400 based on the FIFO depth 410 reaching a threshold value may include step 544.

Pushing FIFO nodes back on to the lock-free FIFO 400 has more steps than popping FIFO nodes from the lock-free FIFO 400. When a FIFO node is popped only the FIFO head 405 and the FIFO depth 410 needs to be updated. When a FIFO node is pushed the FIFO tail 415, FIFO depth 410, and the next value in the FIFO node that is no longer the FIFO tail node needs to be updated. Two CAS operations are performed, a first CAS to update the next value and a second CAS to update the FIFO tail 415 and FIFO depth 410. The ordering of these CAS operations is important—by updating the next value in the current FIFO tail node of the lock-free FIFO nodes 450 before the FIFO tail 415 is updated, it is possible to ensure exclusive access by only one thread when updating the FIFO tail pointer 415. Once the FIFO tail 415 is updated, the new FIFO tail node may be read by another thread to perform another push operation or another pop operation (to check for the lock-free FIFO being empty). Therefore, it is important that the FIFO tail 415 is accurate.

Another complication for the push operation is due to the fact that FIFO nodes may be popped and pushed simultaneously and a FIFO node having a particular index may actually be popped by a first thread and then pushed back onto the lock-free FIFO 400 while a second thread attempts to pop the FIFO node. This is a classic ABA problem in which the second thread uses the “next” value of the FIFO node when the FIFO node was first popped instead of using the “next” value of the FIFO node after the FIFO node is pushed back onto the lock-free FIFO 400. The second thread does not distinguish between the particular FIFO node having two different “next” values because the index of the FIFO node is unchanged.

To avoid the ABA problem, the index may be set to a different value when a FIFO node is pushed onto the lock-free FIFO 400. For example, when a FIFO node is pushed onto the lock-free FIFO 400 the index for the FIFO node is updated such that the index=old index+maximum FIFO depth. The maximum FIFO depth is the total number of FIFO nodes when all allowable FIFO nodes are pushed onto the lock-free FIFO nodes 450. Detection of rollover of the computed index is necessary to ensure that the FIFO nodes are uniquely identified. The maximum FIFO depth may be stored as a parameter in the lock-free FIFO data structure 401. Importantly, the maximum FIFO depth should never change over the lifetime of the FIFO. Otherwise, the maximum FIFO depth cannot be used to compute the physical location of a FIFO node based on the index associated with the FIFO node. The location of the FIFO node in memory may then be computed as base location+index % maximum FIFO depth (where % is the modulo operator), assuming that index rollover is detected or avoided.

The ABA problem may also be avoided by using the transaction counter 402 as an input for the atomic CAS operations. Because the transaction counter 402 is incremented for each pop operation it uniquely identifies the FIFO nodes, assuming that rollover is detected or avoided.

FIG. 6 is a flow diagram of method steps for pushing a FIFO node onto the lock-free FIFO 400, according to one embodiment of the present invention. Although the method steps are described in conjunction with the systems of FIGS. 1, 2, 3A, 3B, 3C, and 4, persons skilled in the art will understand that any system configured to perform the method steps, in any order, is within the scope of the invention.

The method 600 shown in FIG. 6 is performed by the push engine 460 for each push request to push a new FIFO tail node onto the lock-free FIFO 400. The method 600 is performed for each push request when push requests are simultaneously received from different threads. Therefore, the method 600 may be performed simultaneously for multiple push requests. However, the FIFO tail 415 is updated by only one thread at a time of the different threads to satisfy the push request presented by the one thread.

At step 605 a push request is received from a thread. At step 610 the push engine 460 reads the FIFO tail 415 and the FIFO depth 410. At step 615 the push engine 460 computes a new index for the FIFO node to be pushed onto the lock-free FIFO 400. In one embodiment, the new index for the FIFO node to be pushed onto the lock-free FIFO 400 is the old index increased by the maximum FIFO depth.

At step 620 the push engine 460 reads the “next” value for the current FIFO tail node. Because the current FIFO tail node does not point to another FIFO node the “next” value is a unique “empty next” indicator, e.g., “NULL” if a pointer or “−1” if an index, that does not equal any of the possible index values. At step 622 the push engine 460 determines if the “next” value for the current FIFO tail node equals the “empty next” indicator, and, if not, then another thread already has a push transaction in progress and the push engine 460 returns to step 610 to read the new FIFO tail 415.

At step 622 if the push engine 460 determines if the “next” value for the current FIFO tail node equals the “empty next” indicator, then at step 625 the push engine 460 performs an atomic CAS operation that compares the “next” value read at step 620 with the current “next” value of the FIFO tail node and replaces (or exchanges) the current “next” value of the FIFO tail node with the computed index of the FIFO node being pushed. For example, when the FIFO node including next 440 and data 441 is being pushed, the index of the node containing next 440 replaces the next 435 of the current FIFO tail node.

If, at step 630 the push engine 460 determines that the first CAS operation failed to update the “next” value of the current FIFO tail node, then the push engine 460 returns to step 610 to retry the push request. Importantly, because multiple threads may be attempting to update the next value of the current FIFO tail node at the same time, updating the next value must be performed atomically. The atomic CAS operation to update the next value of the current FIFO tail node is performed for each thread presenting a push request to the push engine 460. The CAS operation succeeds for only one thread and fails for any other threads attempting to simultaneously update the next value of the current FIFO tail node when pushing a FIFO node that will become the FIFO tail node.

Note that when the “next” value of the FIFO tail node is replaced at step 625, but the FIFO tail 415 not yet updated to point to the new FIFO tail node, no thread other than the thread that successfully performed the CAS operation in step 625 can progress past step 630. Only the thread that successfully replaces the “next” value of the FIFO tail node in step 625 will be permitted to update the FIFO tail 415 (in step 640). Consequently, in one embodiment, a thread that fails step 622 may instead read the FIFO tail 415 and only return to step 610 when the value of the FIFO tail 415 changes rather than returning to step 610 immediately after step 622.

If, at step 630 the push engine 460 determines that the first CAS operation did not fail, then at step 640 the push engine 460 performs a second atomic CAS operation that compares the FIFO tail 415 read at step 610 with the current FIFO tail 415 and replaces the current FIFO tail 415 with the computed index of the FIFO node being pushed. The second atomic CAS operation may also update the FIFO depth 410. When a pop occurs simultaneously with the push operation the FIFO head 405 and transaction counter 402 are also updated by the second atomic CAS operation. At step 645 the push request is satisfied and the processing of the push request is done.

Unlike conventional FIFO access techniques that require a thread to first lock access to a FIFO before pushing an entry to or popping an entry from the FIFO, a lock-free mechanism allows multiple threads to attempt to access the FIFO simultaneously. When two or more threads attempt to pop a FIFO node from the FIFO simultaneously, the pop operations are automatically serialized. Similarly, when two or more threads attempt to push a FIFO node to the FIFO simultaneously, the push operations are automatically serialized. Each thread that fails to complete a push or pop operation retries the operation, without locking access to the FIFO, until the push or pop is successful. In this way, at least one thread is always successful on every attempt.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A method of accessing a lock-free first-in first-out (FIFO) sub-system, the method comprising:
receiving a pop request to pop a FIFO head node from the lock-free FIFO;
reading a FIFO head pointer value from a lock-free FIFO data structure;
reading a next value that is included in the FIFO head node and identifies a second FIFO node in the lock-free FIFO;
performing an atomic compare-and-swap operation to compare the FIFO head pointer value with a current FIFO head pointer value stored in the lock-free FIFO data structure; and
if the FIFO head pointer value equals the current FIFO head pointer value for the atomic compare-and-swap operation then exchanging the next value with the current FIFO head pointer value in the lock-free FIFO data structure to update the FIFO head pointer value, or
if the FIFO head pointer value does not equal the current FIFO head pointer value for the atomic compare-and-swap operation then repeating the reading of the FIFO head pointer value, the reading of the next value, and the performing of the atomic compare-and-swap operation.

2. The method of claim 1, wherein the pop request to pop the FIFO head node from the lock-free FIFO is received from a first processing thread and an additional pop request to pop the FIFO head node from the lock-free FIFO is simultaneously received from a second processing thread.

3. The method of claim 2, wherein only one of the first thread and the second thread pops the FIFO head node from the lock-free FIFO during a single clock cycle.

4. The method of claim 1, wherein the FIFO head pointer value is an index that is combined with a base value to compute a location in memory where the FIFO head node is stored.

5. The method of claim 1, further comprising, prior to performing the atomic compare-and-swap operation:
reading a FIFO tail pointer value; and
comparing the FIFO head pointer value to the FIFO tail pointer value to determine if the lock-free FIFO is empty.

6. The method of claim 5, further comprising waiting until the lock-free FIFO is not empty before performing the atomic compare-and-swap operation.

7. The method of claim 1, further comprising refilling the lock-free FIFO with additional FIFO nodes.

8. The method of claim 1, further comprising, after storing the next value as the current FIFO head pointer value, refilling the lock-free FIFO with additional FIFO nodes if the lock-free FIFO is empty.

9. The method of claim 1, further comprising, after storing the next value as the current FIFO head pointer value, refilling the lock-free FIFO with additional FIFO nodes if a depth of the lock-free FIFO is less than a threshold value.

10. The method of claim 1, further comprising:
receiving a push request to push a FIFO node to the lock-free FIFO;
reading a FIFO tail pointer value from the lock-free FIFO data structure;
reading a second next value included in the FIFO tail node;
performing a second atomic compare-and-swap operation to compare the second next value with a current second next value included in the FIFO tail node; and
if the second next value equals the current second next value for the second compare-and-swap operation then performing a third atomic compare-and-swap operation to compare the second next value with a current second next value included in the FIFO tail node, or
if the second next value does not equal the current second next value for the second atomic compare-and-swap operation then repeating the reading of the FIFO tail pointer value, reading of the second next value, and performing the second atomic compare-and-swap operation.

11. The method of claim 10, further comprising storing a third next value that identifies the FIFO node as the current FIFO tail pointer value in the lock-free FIFO data structure to update the FIFO tail pointer value when the second next value equals the current second next value for the third atomic compare-and-swap operation.

12. The method of claim 10, further comprising storing a third next value that identifies the FIFO node as the second next value included in the FIFO tail node when the second next value equals the current second next value for the second atomic compare-and-swap operation.

13. The method of claim 10, further comprising:
reading a maximum FIFO depth value from the lock-free FIFO data structure;
computing a third next value that identifies the FIFO node based on the maximum FIFO depth value.

14. A lock-free first-in first-out (FIFO) sub-system comprising:
a memory that is configured to store a lock-free FIFO data structure and a FIFO head node; and
a pop engine that is configured to:
receive a pop request to pop the FIFO head node from the lock-free FIFO;
read a FIFO head pointer value from the lock-free FIFO data structure;
read a next value that is included in the FIFO head node and identifies a second FIFO node in the lock-free FIFO;
perform an atomic compare-and-swap operation to compare the FIFO head pointer value with a current FIFO head pointer value stored in the lock-free FIFO data structure; and
if the FIFO head pointer value equals the current FIFO head pointer value for the atomic compare-and-swap operation then exchange the next value with the current FIFO head pointer value in the lock-free FIFO data structure to update the FIFO head pointer value, or
if the FIFO head pointer value does not equal the current FIFO head pointer value for the atomic compare-and-swap operation then the FIFO head pointer value is read, the next value is read, and the atomic compare-and-swap operation is performed again.

15. A non-transitory computer-readable storage medium storing instructions that, when executed by a processor, cause the processor to access a lock-free first-in first-out (FIFO) sub-system, by performing the steps of:
receiving a pop request to pop a FIFO head node from the lock-free FIFO;
reading a FIFO head pointer value from a lock-free FIFO data structure;
reading a next value that is included in the FIFO head node and identifies a second FIFO node in the lock-free FIFO;
performing an atomic compare-and-swap operation to compare the FIFO head pointer value with a current FIFO head pointer value stored in the lock-free FIFO data structure; and
if the FIFO head pointer value equals the current FIFO head pointer value for the atomic compare-and-swap operation then exchanging the next value with the current FIFO head pointer value in the lock-free FIFO data structure to update the FIFO head pointer value, or
if the FIFO head pointer value does not equal the current FIFO head pointer value for the atomic compare-and-swap operation then repeating the reading of the FIFO head pointer value, the reading of the next value, and the performing of the atomic compare-and-swap operation.

16. The non-transitory computer-readable storage medium of claim 15, wherein the pop request to pop the FIFO head node from the lock-free FIFO is received from a first processing thread and an additional pop request to pop the FIFO head node from the lock-free FIFO is simultaneously received from a second processing thread.

17. The non-transitory computer-readable storage medium of claim 16, wherein only one of the first thread and the second thread pops the FIFO head node from the lock-free FIFO during a single clock cycle.

18. The non-transitory computer-readable storage medium of claim 15, wherein the FIFO head pointer value is an index that is combined with a base value to compute a location in memory where the FIFO head node is stored.

19. The non-transitory computer-readable storage medium of claim 15, further comprising, prior to performing the atomic compare-and-swap operation:
reading a FIFO tail pointer value; and
comparing the FIFO head pointer value to the FIFO tail pointer value to determine if the lock-free FIFO is empty.

20. The non-transitory computer-readable storage medium of claim 15, further comprising:
receiving a push request to push a FIFO node to the lock-free FIFO;
reading a FIFO tail pointer value from the lock-free FIFO data structure;
reading a second next value included in the FIFO tail node;
performing a second atomic compare-and-swap operation to compare the second next value with a current second next value included in the FIFO tail node; and
if the second next value equals the current second next value for the second atomic compare-and-swap operation then performing a third atomic compare-and-swap operation to compare the second next value with a current second next value included in the FIFO tail node, or
if the second next value does not equal current second next value for the second atomic compare-and-swap operation then repeating the reading of the FIFO tail pointer value, reading of the second next value, and performing the second atomic compare-and-swap operation.
